(19) United States
(12) Patent Application Publication
(10) Pub. No.: US 2018/0094568 A1
(43) Pub. Date: Apr. 5, 2018

(54) WATER JACKET SPACER

(71) Applicant: NOK Corporation, Tokyo (JP)

(72) Inventors: Tokunori YANAGI, Shizuoka (JP); Takuya AMANO, Shizuoka (JP)

(73) Assignee: NOK Corporation, Tokyo (JP)

(21) Appl. No.: 15/563,513

(22) PCT Filed: Feb. 15, 2016
(86) PCT No.: PCT/JP2016/054332

§ 371 Date: Sep. 29, 2017

(30) Foreign Application Priority Data
Apr. 3, 2015 (JP) 2015-077198

(51) Int. Cl. F01P 3/02; F02F 1/14

(52) U.S. Cl. CPC F01P 3/02; F01P 2003/021; F02F 1/14

(57) ABSTRACT

An object of the present invention is to provide a water jacket spacer that can prevent cooling water from entering the space between the water jacket spacer and a bore side inner wall face of a water jacket by a simple structure and can facilitate mounting work into the water jacket. Provided is a water jacket spacer 1 that is inserted into a water jacket 102 and regulates the flow of cooling water flowing into the water jacket 102 from a cooling water inflow port 105a. The water jacket spacer 1 includes a first seal lip 13 that is arranged on the upper end of a spacer main body 10 and is in contact with a bore side inner wall face 102a of the water jacket 102 to seal a gap formed between the bore side inner wall face 102a and the spacer main body 10.

### FIELD OF THE INVENTIONS

The present invention relates to a water jacket spacer, and specifically to a water jacket spacer that can prevent cooling water from entering the space between the water jacket spacer and a bore side inner wall face of a water jacket provided in a cylinder block of an automobile water-cooled engine or the like by a simple structure and can facilitate mounting work into the water jacket.

### BACKGROUND OF THE INVENTIONS

A channel called water jacket for cooling water is provided around a bore wall of a cylinder block of an automobile water-cooled engine or the like, and the cooling water is circulated through this water jacket to cool the bore wall.

A wall temperature in a bore axial direction tends to be higher on a combustion chamber side as a bore upper part and to be lower on a crankshaft side as a bore lower part. It is known that this temperature gradient makes a bore internal diameter dimension non-uniform in the axial direction, thereby increasing the friction of pistons and affecting the fuel efficiency performance of the engine.

Given these circumstances, a technique has been conventionally known that a water jacket spacer is inserted into the water jacket to control cooling efficiency in a bore wall axial direction, thereby reducing a temperature difference in the axial direction to level temperature distribution and reducing the friction of the pistons (Patent Document 1 and 2).

### PATENT DOCUMENTS

Patent Document 1: JP-A-2005-256661

Patent Document 2: JP-A-2007-71039

### SUMMARY

### Problem to be Solved by the Invention

Conventional water jacket spacers are formed of a simple resin or a combination of a resin and a foaming water-absorbing rubber; in both cases, a gap inevitably occurs between the water jacket spacer and a bore side inner wall face of a water jacket. In the case of the water jacket spacer formed of the simple resin, the thickness is set to be smaller than the width of the water jacket considering insertability into the water jacket, and a gap inevitably occurs between the water jacket spacer and the inner wall face. In the case of the combination of the resin and the foaming water-absorbing rubber, it is considered that deterioration in terms of durability (permanent deformation) is large, and deterioration occurs when the rubber swells in the middle of water absorption and high temperature, in that state the temperature decreases, and the volume decreases, whereby the gap occurs.

When a gap occurs between the water jacket spacer and the bore side inner wall face of the water jacket, cooling water flows also through this gap, and the bore lower part is also cooled, whereby a temperature gradient in a bore axial direction increases, which may degrade the function of the water jacket spacer.

Patent Document 1 also discloses that a leaf spring or a wedge as a separate member is inserted into the water jacket, and the water jacket spacer is pressed against the bore side inner wall face of the water jacket. However, the structure is complicated, which may make mounting work into the water jacket troublesome.

Given these circumstances, an object of the present invention is to provide a water jacket spacer that can prevent cooling water from entering the space between the water jacket spacer and a bore side inner wall face of a water jacket by a simple structure and can facilitate mounting work into the water jacket.

Other objects of the present invention will be apparent from the descriptions below.

### Means for Solving Problem

The above-described problems are solved by the following respective inventions.

1. A water jacket spacer that is inserted into a water jacket provided in a cylinder block around a bore and regulates a flow of cooling water flowing into the water jacket from a cooling water inflow port that opens to an inner wall face of the water jacket, the water jacket spacer comprising:
a first seal lip that is arranged on an upper end of a spacer main body and is in contact with a bore side inner wall face of the water jacket to seal a gap formed between the bore side inner wall face and the spacer main body.

2. The water jacket spacer according to 1, further comprising a second seal lip that is arranged on the upper end of the spacer main body and is in contact with a counter bore side inner wall face of the water jacket to undergo elastic deformation and brings the first seal lip into intimate contact with the bore side inner wall face of the water jacket through a reaction force during the elastic deformation.

3. The water jacket spacer according to 2, wherein the second seal lip is formed in a length that comes into contact with a blocking member that blocks an upper part of the water jacket when the water jacket spacer is inserted into the water jacket and performs both positioning of the spacer main body in a height direction and detachment prevention for the spacer main body together with the blocking member.

4. The water jacket spacer according to 1, further comprising a detachment prevention member that is arranged between a blocking member that blocks an upper part of the water jacket and the spacer main body and performs positioning of the spacer main body in a height direction and detachment prevention for the spacer main body.

5. The water jacket spacer according to 4, further comprising a protrusion to reducing insertion resistance to the water jacket, the protrusion being formed on a surface of the detachment prevention member on the first seal lip side.

6. The water jacket spacer according to 5, wherein the protrusion is formed in a tapered shape in which a protruding height decreases toward a lower part of the water jacket.

7. The water jacket spacer according to 4, further comprising a protrusion to reducing insertion resistance to the water jacket, the protrusion being formed on a surface of the first seal lip on the detachment prevention member side.

8. The water jacket spacer according to 7, wherein the protrusion is formed in a tapered shape in which a protruding height increases toward a lower part of the water jacket.

9. The water jacket spacer according to any one of 1 to 8, further comprising a bead or a third seal lip that is in intimate contact with the bore side inner wall face or the counter bore side inner wall face of the water jacket at a lower end of the spacer main body.

10. The water jacket spacer according to any one of 1 to 9, wherein the first seal lip contains solid rubber.

11. The water jacket spacer according to 2 or 3, wherein the second seal lip contains solid rubber.

### Effect of the Invention

The present invention can provide a water jacket spacer that can prevent cooling water from entering the space between the water jacket spacer and a bore side inner wall face of a water jacket by a simple structure and can facilitate mounting work into the water jacket.

### BRIEF DESCRIPTION OF THE DRAWINGS

FIG. 1 is a plan view of a cylinder block of a water-cooled engine in which a water jacket spacer according to a first embodiment of the present invention is used;

FIG. 2 is a sectional view along the line (ii)-(ii) in FIG. 1;

FIG. 3 is a sectional view of the water jacket spacer according to the first embodiment removed from a water jacket;

FIG. 4 is a perspective view of an example of a detachment prevention member;

FIG. 5(a) is a perspective view of another example of the detachment prevention member, and FIG. 5(b) is a partial transverse sectional view of the detachment prevention member illustrated in FIG. 5(a) illustrating protrusions;

FIG. 6 is a sectional view of the cylinder block into which the water jacket spacer having the detachment prevention member illustrated in FIG. 5 has been inserted;

FIG. 7 is a plan view of the cylinder block of a water-cooled engine in which a water jacket spacer according to a second embodiment of the present invention is used;

FIG. 8 is a sectional view along the line (viii)-(viii) in FIG. 7;

FIG. 9 is a sectional view of the water jacket spacer according to the second embodiment removed from the water jacket;

FIG. 10 is a partially sectional perspective view illustrating a second seal lip of the water jacket spacer according to the second embodiment;

FIG. 11 is a sectional view of the water jacket spacer illustrating an example in which a tapered part is formed in a spacer main body;

FIG. 12 is a sectional view of the water jacket spacer illustrating an example in which a bead is formed at the lower end of the spacer main body;

FIG. 13(a) and FIG. 13(b) are sectional views of the water jacket spacer illustrating an example in which a third seal lip is formed at the lower end of the spacer main body.

### DETAILED DESCRIPTION OF THE INVENTIONS

The following describes embodiments of the present invention with reference to the accompanying drawings.

### First Embodiment

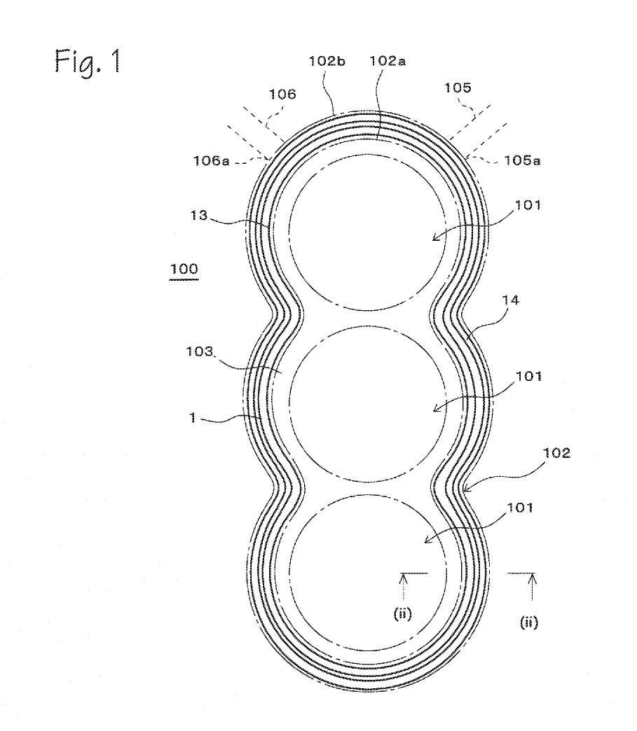

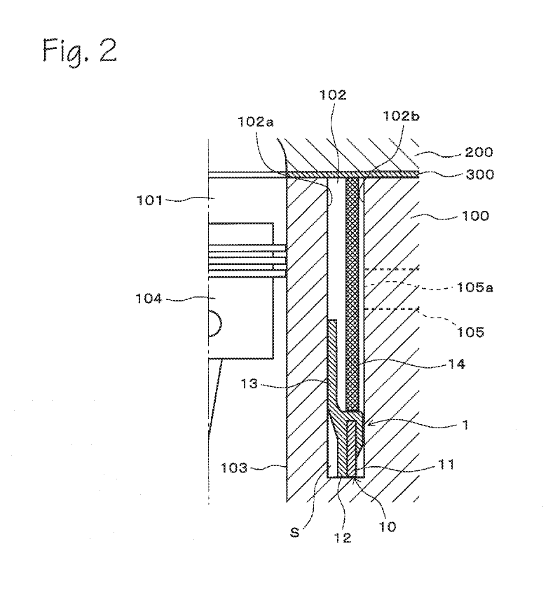

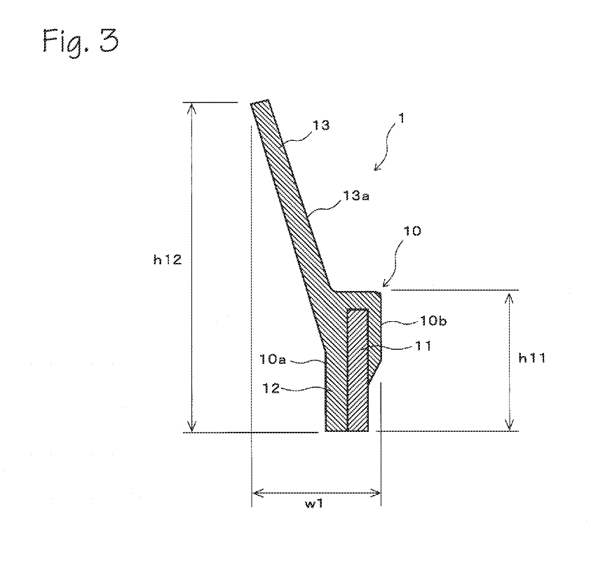

FIG. 1 is a plan view of a cylinder block of a water-cooled engine in which a water jacket spacer according to a first embodiment of the present invention is used, in which the cylinder block is indicated by a dot-and-dash line. FIG. 2 is sectional view along the line (ii)-(ii) in FIG. 1. FIG. 3 is a sectional view of the water jacket spacer according to the first embodiment removed from a water jacket.

The cylinder block 100 is formed with a plurality of bores 101 and an open deck type channel-shaped water jacket 102 surrounding the bores 101. A bore wall 103 is between the bores 101 and the water jacket 102. Within each of the bores 101, a piston 104 is arranged in a reciprocatable manner in an axial direction (in the up-and-down direction in FIG. 2).

Cooling water is supplied to the inside of the water jacket 102 via a cooling water supply channel 105 formed in the cylinder block 100, and the inside cooling water is discharged via a cooling water discharge channel 106. A cooling water inflow port 105a and a cooling water outflow port 106a are positioned at a certain height of a counter bore side inner wall face 102b of the water jacket 102 and both open.

As illustrated in FIG. 2, a cylinder head 200 is provided above the cylinder block 100. The cylinder head 200 is fixed with bolts (not illustrated) via a cylinder head gasket 300 interposed between the cylinder head 200 and the cylinder block 100. With this structure, the upper part of the bores 101 are blocked by the cylinder head 200, and the upper part of the water jacket 102 is blocked by the cylinder head 200 and the cylinder head gasket 300. The cylinder head 200 and the cylinder head gasket 300 are blocking members that block the upper part of the water jacket 102. However, the cylinder head gasket 300 is not necessarily required to block the upper part of the water jacket 102.

A water jacket spacer 1 is inserted into the water jacket 102. In the water jacket spacer 1, a spacer main body 10 includes a synthetic resin core 11 and an elastic body 12 that is formed to cover the surface of this synthetic resin core 11.

The synthetic resin core 11 is formed to have a shape substantially similar to the plan shape of the bore wall 103. In other words, the synthetic resin core 11 is formed in a ring shape in which a plurality of cylindrical faces are connected in a wave shape to extend along the entire perimeter of the water jacket 102 so as to surround the bores 101. Examples of the resin material of the synthetic resin core 11 include a polyamide resin.

The elastic body 12 is provided across the entire perimeter of the synthetic resin core 11. For the elastic body 12, rubber is generally used, which is preferably a type of rubber that is non-foaming and does not contain any water-absorbing polymer material, that is, solid rubber. The solid rubber hardly causes swelling caused by the absorption of water like the one in a foaming water-absorbing rubber and is not likely to cause deterioration by being heated in a swelled state, thereby suppressing degrading after endurance. Consequently, the elastic body 12 formed of the solid rubber increases in adhesion with a bore side inner wall face 102a and the counter bore side inner wall face 102b of the water jacket 102. In addition, the initial insertion resistance of the water jacket spacer 1 can be significantly reduced, which makes inserting work into the water jacket 102 easy.

Preferable examples of the solid rubber include ethylene-propylene rubber (EPDM), hydrogenated nitrile rubber (HNBR), and fluorine rubber (FKM). Such solid rubber can be integrated with the surface of the synthetic resin core 11 by baking. Although not illustrated, the solid rubber may be mechanically fixed to the synthetic resin core 11 in a non-adhesion manner by drilling a hole in the synthetic resin core 11 and covering the synthetic resin core 11 with the solid rubber so as to cause the solid rubber to pass through this hole.

The dimension of a height h11 (refer to FIG. 3) from the upper end to the lower end of this spacer main body 10 is smaller than the dimension of the depth of the water jacket 102 as appropriate. Specifically, the spacer main body 10 is formed such that, when this water jacket spacer 1 is inserted into a lower part within the water jacket 102, the position of the upper end of the spacer main body 10 will be lower than the opening position of the cooling water inflow port 105a and the cooling water outflow port 106a (FIG. 2 illustrates only the cooling water inflow port 105a).

The spacer main body 10 is formed with a first seal lip 13 on the upper end of its inner side face (a side face on the bores 101 side) 10a. This first seal lip 13 is formed integrally with the elastic body 12 of the same elastic body as the elastic body 12 and preferably of the same solid rubber as that of the elastic body 12.

As illustrated in FIG. 3, the first seal lip 13 is formed so as to extend from the upper end of the inner side face 10a of the spacer main body 10 obliquely upward on the inside of the spacer main body 10. This first seal lip 13 is formed across the entire perimeter of the spacer main body 10.

A width w1 from the tip of the first seal lip 13 to an outer side face (a side face on the counter bore side) 10b of the spacer main body 10 is larger than the channel width of the water jacket 102. A height h12 from the upper end of the first seal lip 13 to the lower end of the spacer main body 10 is sufficiently larger than the height h11 of the spacer main body 10. With this structure, the first seal lip 13 forms sufficiently large interference in the width direction relative to the water jacket 102.

The dimension of this height h12 is formed to be smaller than the dimension of the depth of the water jacket 102. In the present embodiment, the height h12 is about half the depth of the water jacket 102. As described below, this first seal lip 13 is intimate contact with the bore side inner wall face 102a of the water jacket 102, thereby forming an area with which the cooling water is difficult to come into contact across the entire perimeter of the bore side inner wall face 102a. For this purpose, this height h12 is set according to the desired cooling efficiency in the axial direction of the bore wall 103.

The water jacket spacer 1 is inserted into the lower part within the water jacket 102 so as to cause the first seal lip 13 to be directed upward relative to the spacer main body 10. The width w1 of the water jacket spacer 1 is larger than the channel width of the water jacket 102, and the first seal lip 13 undergoes elastic deformation along the bore side inner wall face 102a of the water jacket 102 to come into intimate contact with the entire perimeter of the bore side inner wall face 102a as illustrated in FIG. 2.

Through a reaction force when this first seal lip 13 has undergone elastic deformation, the upper end side of the spacer main body 10 is biased so as to be pressed toward the counter bore side, and the upper end side of the outer side face 10b of the spacer main body 10 comes into contact with the counter bore side inner wall face 102b of the water jacket 102. With this contact, the water jacket spacer 1 is positioned within the water jacket 102.

In this process, a gap S is formed between the bore side inner wall face 102a lower than the first seal lip 13 and the spacer main body 10. However, owing to the fact that the first seal lip 13 is in intimate contact with the bore side inner wall face 102a to seal the gap S and that the cooling water inflow port 105a opens at the position upper than the spacer main body 10, the cooling water that has flowed into the water jacket 102 is difficult to enter the gap S.

Consequently, on the bore upper side, which is relatively high in temperature, the cooling water with a high flow rate can efficiently perform cooling, whereas on the bore lower side, which is relatively low in temperature, the area with which the cooling water is difficult to come into contact is formed by the first seal lip 13 being in intimate contact with the bore side inner wall face 102a, and further, an air insulation effect is exerted within the gap S lower than the first seal lip 13, whereby cooling is retarded. Even if the cooling water enters the gap S, the flow rate of the cooling water within the gap S extremely decreases, and cooling is retarded compared with the bore upper side.

Thus, the water jacket spacer 1 brings a member having a simple structure that the water jacket spacer 1 itself has, or the first seal lip 13, into intimate contact with the bore side inner wall face 102a of the water jacket 102 to seal it, thereby extremely preventing the cooling water from entering the space between the bore side inner wall face 102a and the spacer main body 10. Consequently, an effect intrinsic to the water jacket spacer of leveling the temperature distribution in the axial direction of the bore wall 103 to reduce the friction of the piston 104 is obtained.

In addition, this water jacket spacer 1 eliminates a separate member for pressing the water jacket spacer 1 toward the bore side inner wall face 102a of the water jacket 102. The mounting work of the water jacket spacer 1 is very simple as it is only necessary to insert it into the water jacket 102.

This water jacket spacer 1 is held between the bore side inner wall face 102a and the counter bore side inner wall face 102b by causing the outer side face 10b of the spacer main body 10 to be pressed against the counter bore side inner wall face 102b of the water jacket 102 by the reaction force when the first seal lip 13 has undergone elastic deformation, can be positioned in the height direction within the water jacket 102, and can be prevented from being detached upward. To further ensure this effect, the water jacket spacer 1 preferably further includes a detachment prevention member 14 as illustrate din FIG. 2.

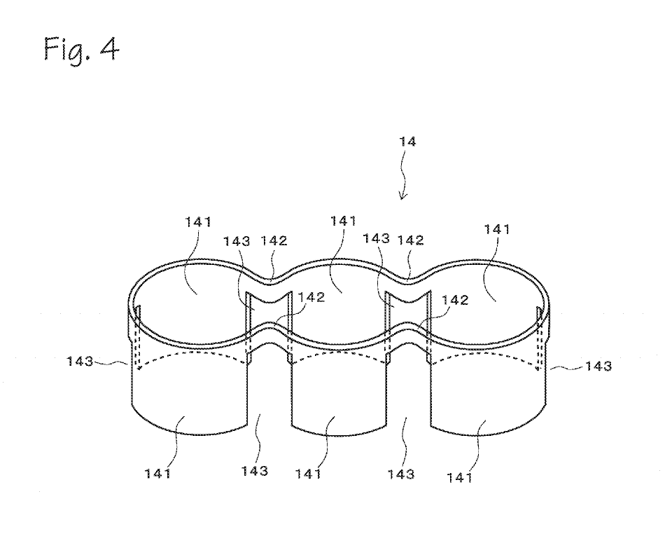

The following further describes this detachment prevention member 14 with reference to FIG. 4.

The detachment prevention member 14 is formed to have a shape substantially similar to the plan shape of the bore wall 103 similarly to the synthetic resin core 11 of the spacer main body 10. In other words, the detachment prevention member 14 is formed in a ring shape in which a plurality of cylindrical faces are connected in a wave shape so as to surround the bores 101.

More specifically, the detachment prevention member 14 has a shape in which the upper ends of a plurality of curved plates 141 are connected to each other with connecting parts 142. Gaps 143 with a certain width are formed between adjacent curved plates 141 and 141, and the cooling water can circulate between the inside and the outside of the detachment prevention member 14 via these gaps 143. Although six curved plates 141 are connected via the connecting parts 142 to form the detachment prevention member 14 in this example, the number of the curved plates 141 is not limited to any particular number.

This detachment prevention member 14 can be formed of a synthetic resin material similar to that of the synthetic resin core 11. As illustrated in FIG. 2, the height of the detachment prevention member 14 is set to a height stretching from the upper end face of the spacer main body 10 inserted into the lower part within the water jacket 102 to the blocking member (the cylinder head gasket 300 in FIG. 2) that blocks the water jacket 102.

When inserted into the water jacket 102, the detachment prevention member 14 is pressed by the cylinder head gasket 300 as the blocking member, thereby imparting a downward pressing force to the spacer main body 10 between the first seal lip 13 and the counter bore side inner wall face 102b of the water jacket 102. With this force, the spacer main body 10 is effectively prevented from being detached upward.

When the spacer main body 10 is inserted into the water jacket 102, the first seal lip 13 comes into contact with the counter bore side inner wall face 102a of the water jacket 102 to undergo elastic deformation, thereby increasing insertion resistance; using the detachment prevention member 14 can cause the spacer main body 10 to be easily inserted into the lower part within the water jacket 102. The detachment prevention member 14 is an integral member with the curved plates 141 connected with the connecting parts 142, and inserting work into the water jacket 102 is simple.

The detachment prevention member 14 has the gaps 143 through which the cooling water can circulate and can cause the cooling water to circulate also between the detachment prevention member 14 and the bore side inner wall face 102a of the water jacket 102. Consequently, there is no hindrance to the cooling of the bore wall 103 upper than the first seal lip 13.

The gaps 143 may be formed at least at part of the detachment prevention member 14 and preferably at least at parts at which the cooling water inflow port 105a and the cooling water outflow port 106a open. In place of or in addition to the gaps 143, the curved plates 141 may be provided with through holes through which the cooling water can circulate.

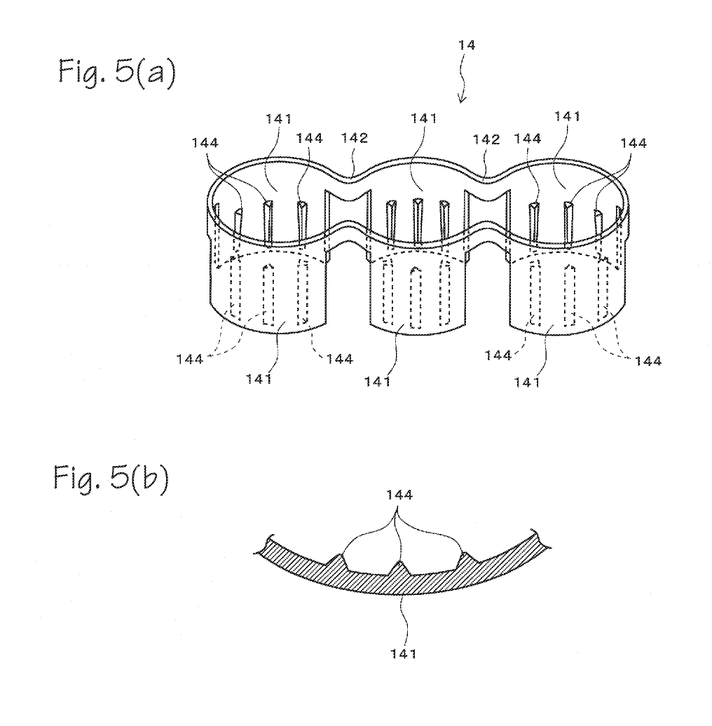

FIG. 5 illustrates a more favorable form of the detachment prevention member 14.

As illustrated in FIG. 5(a), this detachment prevention member 14 is formed with protrusions 144 on the inner faces of the respective curved plates 141, that is, the surfaces on the first seal lip 13 side. The protrusions 144 are formed of protruding streaks linearly extending in the height direction of the respective curved plates 141 and are arranged in parallel in the width direction for each of the curved plates 141 to show a comb shape. Although this example illustrates a case in which three protrusions 144 are arranged in each of the curved plates 141, the number of the protrusions 144 is not limited to any particular number.

As illustrated in FIG. 5(b), the transverse sectional shape of each of the protrusions 144 is formed in a triangular shape protruding toward the inside of the detachment prevention member 14. Consequently, when being inserted into the water jacket 102, the detachment prevention member 14 having these protrusions 144 comes into linear contact with a side face 13a on the counter bore side of the first seal lip 13 (refer to FIG. 3) and can thereby reduce the insertion resistance of the detachment prevention member 14. In addition, the protrusions 144 exert a pressing force directed toward the bore side inner wall face 102a of the water jacket 102 on the first seal lip 13 and can thereby further ensure the sealing function by the first seal lip 13.

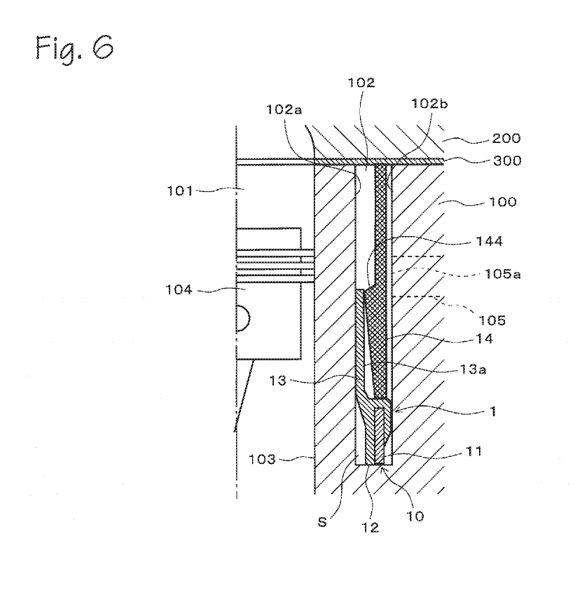

As illustrated in FIG. 6, the protrusions 144 are preferably formed in a tapered shape in which their inward protruding height decreases toward the lower part of the water jacket 102. With this structure, the workability of the detachment prevention member 14 during insertion can be further improved.

Although not illustrated, the protrusions may be formed integrally with the surface of the first seal lip 13 on the detachment prevention member 14 side, that is, the side face 13a on the counter bore side in place of being formed on the detachment prevention member 14. In this case, the workability of the detachment prevention member 14 during insertion is preferably improved similarly to the above by forming the protrusions so as to cause their outward protruding height to increase toward the lower part of the water jacket 102.

### Second Embodiment

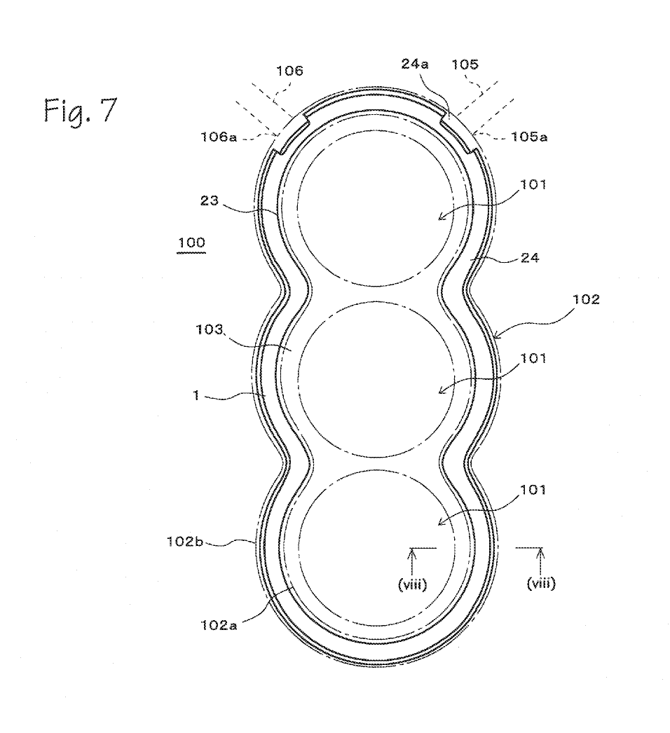

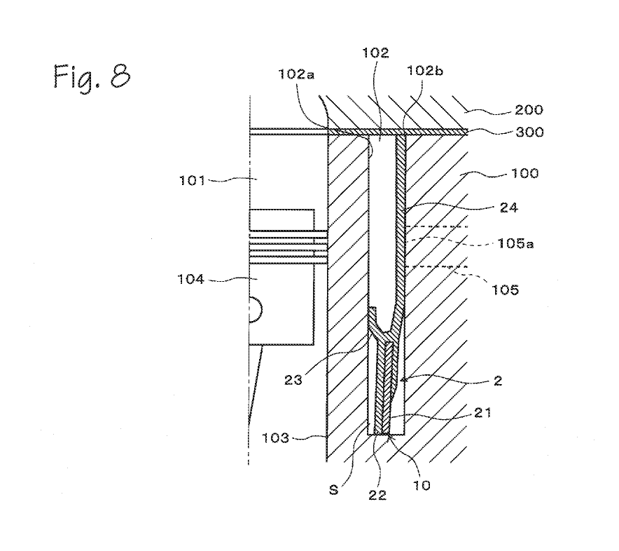

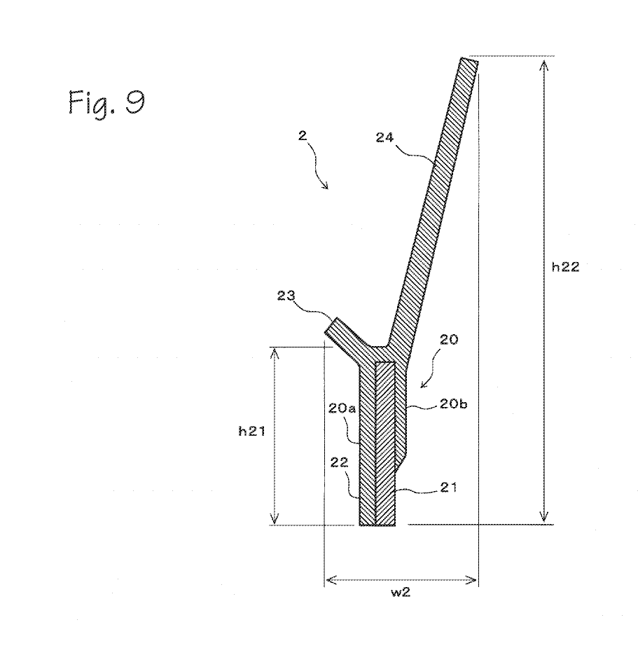

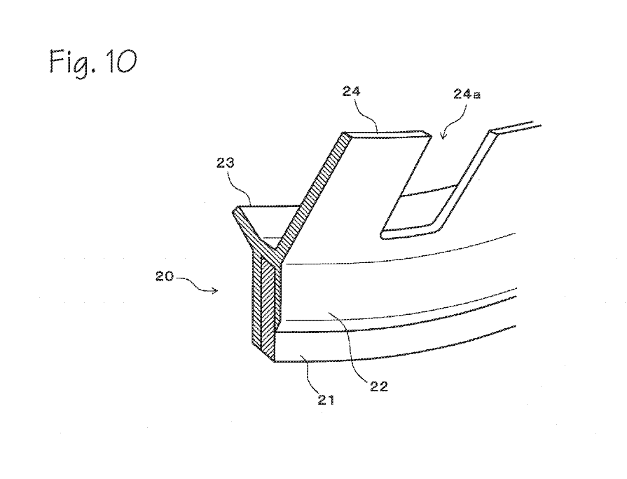

FIG. 7 is a plan view of the cylinder block of a water-cooled engine in which a water jacket spacer according to a second embodiment of the present invention is used, in which the cylinder block is indicated by a dot-and-dash line. FIG. 8 is a sectional view along the line (viii)-(viii) in FIG. 7, FIG. 9 is a sectional view of the water jacket spacer according to the second embodiment removed from the water jacket, and FIG. 10 is a partially sectional perspective view illustrating a second seal lip of the water jacket spacer according to the second embodiment.

In this water jacket spacer 2, a spacer main body 20 includes a synthetic resin core 21 and an elastic body 22 that is formed to cover the surface of this synthetic resin core 21. The synthetic resin core 21 and the elastic body 22 are the same materials as those of the synthetic resin core 11 and the elastic body 12, respectively, in the first embodiment.

The dimension of a height h21 (refer to FIG. 9) from the upper end to the lower end of this spacer main body 20 is also smaller than the dimension of the depth of the water jacket 102 as appropriate. Specifically, the spacer main body 20 is formed such that, when this water jacket spacer 2 is inserted into the lower part within the water jacket 102, the position of the upper end of the spacer main body 20 will be lower than the opening position of the cooling water inflow port 105a and the cooling water outflow port 106a (FIG. 8 illustrates only the cooling water inflow port 105a).

In the spacer main body 20, similarly to the water jacket spacer 1 according to the first embodiment, a first seal lip 23 extending obliquely upward on the inside of the spacer main body 20 is integrally formed on the upper end of its inner side face 20a across the entire perimeter of the spacer main body 20. This first seal lip 23 is formed to be shorter than the first seal lip 13 in the first embodiment.

In the spacer main body 20, a second seal lip 24 extending obliquely upward on the outside of the spacer main body 20 is integrally formed on the upper end of its outer side face 20b. The protruding length of this second seal lip 24 from the spacer main body 20 is formed to be sufficiently longer than the first seal lip 23.

The length of the second seal lip 24 is formed such that, when the water jacket spacer 2 is inserted into the water jacket 102, its tip will come into contact with the cylinder head gasket 300.

This second seal lip 24, which extends across the entire perimeter of the spacer main body 20, has a notch 24a notched in the height direction at least partly as illustrated in FIG. 10. Consequently, the cooling water that has flowed into the water jacket 102 from the cooling water inflow port 105a can circulate from the outside of the second seal lip 24 toward the inside bore wall 103 via this notch 24a. As illustrated in FIG. 7, the notch 24a is preferably formed at least at parts at which the cooling water inflow port 105a and the cooling water outflow port 106a open.

The first seal lip 23 and the second seal lip 24 are integrally formed of the same elastic body as the elastic body 22 that covers the synthetic resin core 21 similarly to the first seal lip 13 in the first embodiment.

A width w2 from the tip of the first seal lip 23 to the tip of the second seal lip 24 is formed to be larger than the width of the water jacket 102. A height h22 from the upper end of the second seal lip 24 to the lower end of the spacer main body 20 is formed to be sufficiently larger than the height h21 of the spacer main body 20. With these dimensions, the first seal lip 23 and the second seal lip 24 form interference in the width direction relative to the water jacket 102.

The water jacket spacer 2 is inserted into the lower part within the water jacket 102 such that the first seal lip 23 and the second seal lip 24 will be directed upward relative to the spacer main body 20. The width w2 of the water jacket spacer 2 is larger than the width of the water jacket 102, and in addition, the second seal lip 24 is formed to be longer than the first seal lip 23 in the protruding length, and the second seal lip 24 first undergoes elastic deformation along the counter bore side inner wall face 102b of the water jacket 102 and comes into contact with the counter bore side inner wall face 102b as illustrated in FIG. 8.

The spacer main body 20 is biased so as to cause the upper end side of the inner side face 20a to be pressed toward the bores 101 through a reaction force when this second seal lip 24 has undergone elastic deformation. With this biasing, the first seal lip 23 comes into contact with the bore side inner wall face 102a of the water jacket 102 to undergo elastic deformation and comes into intimate contact with the bore side inner wall face 102a to seal it. Consequently, this water jacket spacer 2 causes the first seal lip 23 and the second seal lip 24 to come into intimate contact with the bore side inner wall face 102a and the counter bore side inner wall face 102b, respectively, of the water jacket 102 to achieve a self-sealing function.

Also in this case, the gap S is formed between the bore side inner wall face 102a and the spacer main body 20. However, owing to the fact that the first seal lip 23 is in intimate contact with the bore side inner wall face 102a and that the cooling water inflow port 105a opens at the position upper than the spacer main body 20, even if the cooling water flows into the water jacket 102, the cooling water is difficult to enter this gap S similarly to the first embodiment.

Consequently, on the bore upper side, which is relatively high in temperature, the cooling water with a high flow rate can efficiently perform cooling, whereas on the bore lower side, which is relatively low in temperature, the first seal lip 23 makes it difficult for the cooling water to enter the gap S, whereby an air insulation effect is exerted and the flow rate of the cooling water extremely decreases within the gap S, and cooling is retarded similarly to the first embodiment.

Thus, the water jacket spacer 2 can prevent the cooling water from entering the space between the water jacket spacer 2 and the bore side inner wall face 102a of the water jacket 102 by the first seal lip 23 and the second seal lip 24, which are members having simple structures that the water jacket spacer 2 itself has. In addition, the water jacket spacer 2 allows the mounting work to be extremely simple, thus achieving effects similar to those by the first embodiment.

Furthermore, in this water jacket spacer 2, the second seal lip 24, which is sufficiently larger than the first seal lip 23, comes into contact with the counter bore side inner wall face 102b to undergo elastic deformation so as to lean toward the bores 101 and can cause the first seal lip 23 to exert a pressing force on the bore side inner wall face 102a. With this pressing force, the first seal lip 23 can be brought into intimate contact with the bore side inner wall face 102a strongly, and the sealing function by the first seal lip 23 can be further improved.

Although the length of the second seal lip 24 illustrated in FIG. 8 is formed in a length that comes into contact with the cylinder head gasket 300 as the blocking member when the water jacket spacer 2 is inserted into the water jacket 102, the length may be formed in a length short enough not to slightly come into contact with the cylinder head gasket 300.

If the second seal lip 24 is formed in the length that comes into contact with the cylinder head gasket 300 as the blocking member, the second seal lip 24 comes into contact with the cylinder head gasket 300, thereby enabling a downward pressing force to be exerted on the spacer main body 20 by the elasticity of the second seal lip 24. With this pressing force, the positioning of the water jacket spacer 2 in the height direction and upward detachment prevention for the water jacket spacer 2 are performed. In other words, the second seal lip 24 is used for both positioning and detachment prevention. This form is a favorable form, because there is no need to separately provide some members for the positioning of and detachment prevention for the water jacket spacer 2, and the structure can be made simpler.

If the second seal lip 24 is formed in the length that does not slightly come into contact with the cylinder head gasket 300 as the blocking member, even if the water jacket spacer 2 floats up within the water jacket 102, the second seal lip 24 comes into contact with the cylinder head gasket 300 and can prevent floating up more than that. In this case, the gap between the second seal lip 24 and the cylinder head gasket 300 may be set as appropriate to such an extent that the floating up of the water jacket spacer 2 does not impair the function as the water jacket spacer 2.

### Other Embodiments

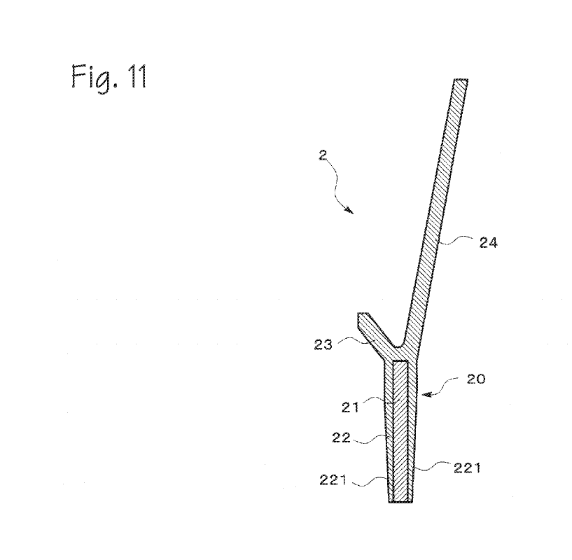

As illustrated in FIG. 11, the spacer main body 20 of the water jacket spacer 2 can be formed with a tapered part 221 that becomes thinner toward the lower end. The tapered part 221 is formed by gradually thinning the elastic body 22 on both sides of the synthetic resin core 21 toward the lower end. With this structure, demolding when the water jacket spacer 2 has been molded can be made favorable.

Such a tapered part can also be formed in the water jacket spacer 1 according to the first embodiment similarly.

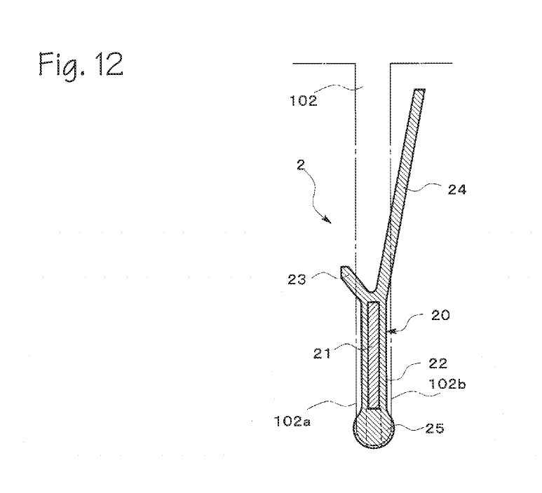

FIG. 12 illustrates an example in which a bead 25 is formed at the lower end of the spacer main body 20. The bead 25 is integrally formed of the same elastic body as the elastic body 22 on both sides of the synthetic resin core 21 across the entire perimeter of the water jacket spacer 2. This bead 25 protrudes inward, outward, and downward of the spacer main body 20 from the lower end of the spacer main body 20. The width of the bead 25 is slightly larger than the channel width of the water jacket 102.

When this water jacket spacer 2 is inserted into the water jacket 102, the bead 25 comes into intimate contact with the bore side inner wall face 102a and the counter bore side inner wall face 102b near the bottom of the water jacket 102. With this intimate contact, the cooling water flowing through the space on the counter bore side inner wall face 102b side is difficult to circulate below the water jacket spacer 2, and the cooling water can be further prevented from passing below the water jacket spacer 2 to flow into the space on the bore side inner wall face 102a side.

The bead may be formed so as to be intimate contact with only either the bore side inner wall face 102a or the counter bore side inner wall face 102b of the water jacket 102. Such a bead can also be formed in the water jacket spacer 1 according to the first embodiment similarly.

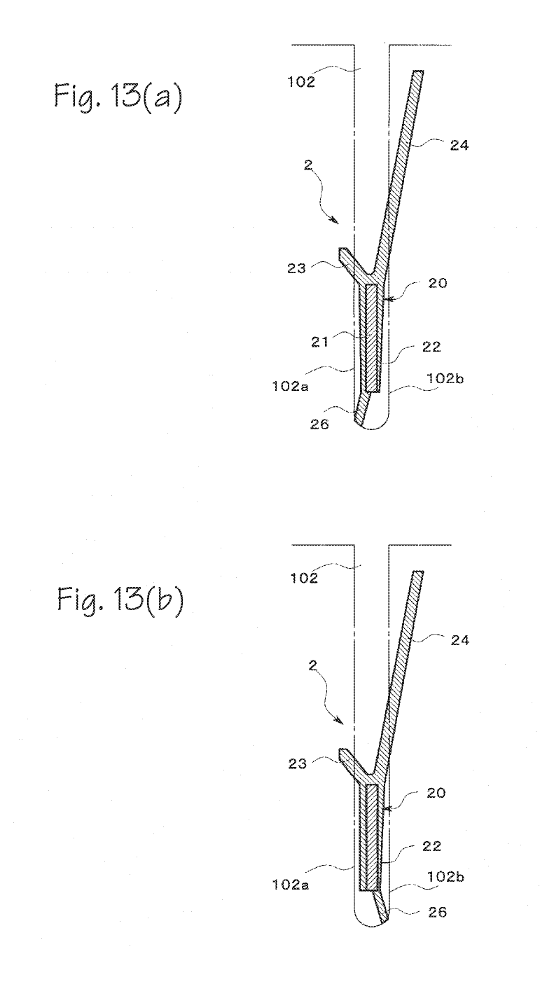

FIG. 13(a) and FIG. 13(b) illustrate examples in which a third seal lip 26 is formed at the lower end of the spacer main body 20. The third seal lip 26 illustrated in FIG. 13(a) is formed so as to extend obliquely downward from the lower end of the spacer main body 20 toward the bore side inner wall face 102a of the water jacket 102. The third seal lip 26 illustrated in FIG. 13(b) is formed so as to extend obliquely downward from the lower end of the spacer main body 20 toward the counter bore side inner wall face 102b of the water jacket 102. The third seal lip 26 is formed integrally with the elastic body 22 of the spacer main body 20 across the entire perimeter of the water jacket spacer 2.

When the water jacket spacer 2 is inserted into the water jacket 102, the third seal lip 26 comes into intimate contact with the bore side inner wall face 102a or the counter bore side inner wall face 102b near the bottom of the water jacket 102. With this intimate contact, the cooling water flowing through the space on the counter bore side inner wall face 102b side can be further prevented from passing below the water jacket spacer 2 to flow into the space on the bore side inner wall face 102a side.

Such a third seal lip can also be formed in the water jacket spacer 1 according to the first embodiment similarly.

### REFERENCE SIGNS LIST

1: Water jacket spacer

10: Spacer main body

11: Synthetic resin core

12: Elastic body

13: First seal lip

13a: Side face on the counter bore side

14: Detachment prevention member

141: Curved plate

142: Connecting part

143: Gap

144: Protrusion

2: Water jacket spacer

20: Spacer main body

21: Synthetic resin core

22: Elastic body

23: First seal lip

24: Second seal lip

24a: Notch

25: Bead

26: Third seal lip

100: Cylinder block

101: Bore

102: Water jacket

102a: Bore side inner wall face

102b: Counter bore side inner wall face

103: Bore wall

104: Piston

105: Cooling water supply channel

105a: Cooling water inflow port

106: Cooling water discharge channel

106a: Cooling water outflow port

200: Cylinder head

300: Cylinder head gasket

S: Gap.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

1. (canceled)

2. (canceled)

3. A water jacket spacer that is inserted into a water jacket provided in a cylinder block around a bore and regulates a flow of cooling water flowing into the water jacket from a cooling water inflow port that opens to an inner wall face of the water jacket, the water jacket spacer comprising:
a first seal lip that is arranged on an upper end of a spacer main body and is in contact with a bore side inner wall face of the water jacket to seal a gap formed between the bore side inner wall face and the spacer main body; and
a second seal lip that is arranged on the upper end of the spacer main body and is in contact with a counter bore side inner wall face of the water jacket to undergo elastic deformation and brings the first seal lip into intimate contact with the bore side inner wall face of the water jacket through a reaction force during the elastic deformation,
the second seal lip being formed in a length that comes into contact with a blocking member that blocks an upper part of the water jacket when the water jacket spacer is inserted into the water jacket and performing both positioning of the spacer main body in a height direction and detachment prevention for the spacer main body together with the blocking member.

4. (canceled)

5. A water jacket spacer that is inserted into a water jacket provided in a cylinder block around a bore and regulates a flow of cooling water flowing into the water jacket from a cooling water inflow port that opens to an inner wall face of the water jacket, the water jacket spacer comprising:
a first seal lip that is arranged on an upper end of a spacer main body and is in contact with a bore side inner wall face of the water jacket to seal a gap formed between the bore side inner wall face and the spacer main body;
a detachment prevention member that is arranged between a blocking member that blocks an upper end of the water jacket and the spacer main body and performs positioning of the spacer main body in a height direction and detachment prevention for the spacer main body; and
a protrusion to reducing insertion resistance to the water jacket, the protrusion being formed on a surface of the detachment prevention member on the first seal lip side.

6. The water jacket spacer according to claim 5, wherein the protrusion is formed in a tapered shape in which a protruding height decreases toward a lower part of the water jacket.

7. The water jacket spacer according to claim 5, further comprising a protrusion to reducing insertion resistance to the water jacket, the protrusion being formed on a surface of the first seal lip on the detachment prevention member side.

8. The water jacket spacer according to claim 7, wherein the protrusion is formed in a tapered shape in which a protruding height increases toward a lower part of the water jacket.

9. The water jacket spacer according to claim 3 further comprising a bead or a third seal lip that is in intimate contact with the bore side inner wall face or the counter bore side inner wall face of the water jacket at a lower end of the spacer main body.

10. The water jacket spacer according to claim 3 wherein the first seal lip contains solid rubber.

11. The water jacket spacer according to claim 3, wherein the second seal lip contains solid rubber.

12. The water jacket spacer according to claim 5 further comprising a bead or a third seal lip that is in intimate contact with the bore side inner wall face or the counter bore side inner wall face of the water jacket at a lower end of the spacer main body.

13. The water jacket spacer according to claim 6 further comprising a bead or a third seal lip that is in intimate contact with the bore side inner wall face or the counter bore side inner wall face of the water jacket at a lower end of the spacer main body.

14. The water jacket spacer according to claim 7 further comprising a bead or a third seal lip that is in intimate contact with the bore side inner wall face or the counter bore side inner wall face of the water jacket at a lower end of the spacer main body.

15. The water jacket spacer according to claim 8 further comprising a bead or a third seal lip that is in intimate contact with the bore side inner wall face or the counter bore side inner wall face of the water jacket at a lower end of the spacer main body.

16. The water jacket spacer according to claim 5 wherein the first seal lip contains solid rubber.

17. The water jacket spacer according to claim 6 wherein the first seal lip contains solid rubber.

18. The water jacket spacer according to claim 7 wherein the first seal lip contains solid rubber.

19. The water jacket spacer according to claim 8 wherein the first seal lip contains solid rubber.

20. The water jacket spacer according to claim 9 wherein the first seal lip contains solid rubber.
